(19) United States
(12) Patent Application Publication
(10) Pub. No.: US 2022/0089798 A1
(43) Pub. Date: Mar. 24, 2022

(54) Ultra-Pure Methyl Vinyl Ether-Co-Maleic Anhydride Copolymers and Methods for Preparing Same

(71) Applicant: Boai NKY Medical Holdings Ltd., Jiaozuo (CN)

(72) Inventors: Herbert Wilhelm Ulmer, Bussum (NL); Jianqiang Wang, Tianjin (CN); Xudong Sun, Tianjin (CN)

(21) Appl. No.: 17/424,939

(22) PCT Filed: Jan. 25, 2019
(86) PCT No.: PCT/CN2019/073231

§ 371 Date: Jul. 22, 2021

(51) Int. Cl. C08F 216/18; C08F 222/06; C08F 6/00

(52) U.S. Cl. CPC C08F 216/18; C08F 6/008; C08F 222/06

(57) ABSTRACT

Ultra-pure methyl vinyl ether-co-maleic anhydride (PMVE/MA) copolymers and the process to produce such ultra-pure polymers by removing trace impurities are provided. A process to provide an ultra-pure methyl vinyl ether-co-maleic anhydride material by solvent washing PMVE/MA copolymer with a solvent, comprises the steps of: (1) providing a solvent system in which impurities in the copolymer matrix are soluble and in which the PMVE/MA copolymer is not soluble, and wherein the solvent system does not react with the copolymer; (2) washing a dry powder or wet filter cake of PMVE/MA copolymer with the solvent system to efficiently and effectively extract trace impurities from the matrix; (3) filtering said copolymer from the solvent system; and (4) drying the subsequent wet filter cake of said copolymer to obtain an ultra-pure methyl vinyl ether-co-maleic anhydride copolymer.

The invention relates to ultra-pure methyl vinyl ether-co-maleic anhydride (PMVE/MA) copolymers and the process to produce such ultra-pure polymers by removing trace impurities. The trace impurities are due to: impurities in the raw materials, impurities associated with competing reactions and impurities due to by-product formation. Removal of these impurities reduces the toxicity concerns of using the copolymer and its derivatives as well as greatly improving the aesthetic characteristics of the resultant copolymers and derivatives with respect to odor, color and taste. This is especially important for applications that require the polymer to have intimate contact with living tissue (e.g. skin, oral cavity, wounds, etc.).

It is generally agreed that high molecular weight biocompatible polymers poise little risk to living cell toxicity because the high molecular weight polymers are not able to cross the cell membrane to affect the cell. It is almost always the small molecular weight impurities within the polymer matrix that poise toxicological risk to the cell. For this reason, the impurities need to be properly managed, with their concentrations being reduced to acceptable levels. Though all small molecules do not have the same toxicological effect on living cells, it is the general goal to limit any small molecule impurities within polymers to as low as possible to reduce the overall risk of using said polymer in a living cell contact application, whether this be pharmaceutical, veterinarian, skin, wound, oral care or other.

In addition to toxicological concerns, small molecule impurities can negatively impact key aesthetic properties such as color, odor, taste and stability and limit their acceptance to consumers. Thus, it is quite apparent that polymers having reduced impurity profiles would be highly desirable.

PMVE/MA copolymer is typically produced by the radical polymerization of methyl vinyl ether (MVE) with maleic anhydride (MA) in organic solvents.

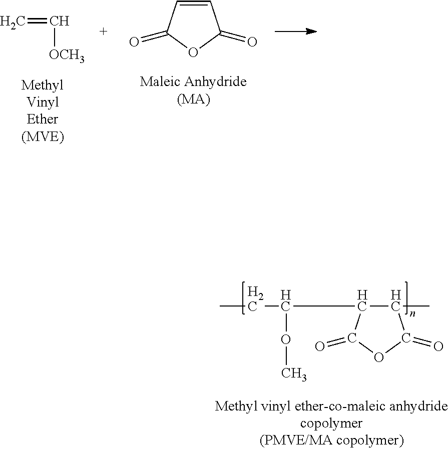

The radical polymerization is carried out in organic solvents to give either a resultant polymer solution or slurry. Examples of radical solution polymerization of PMVE/MA in which the resultant polymer product is a solution is disclosed in U.S. Pat. No. 4,939,198 issued to Tazi et al., where the organic solvent used to carry out the polymerization is acetone in which the resultant PMVE/MA copolymer is freely soluble in. Examples of radical solution polymerization of PMVE/MA in which the resultant polymer product is a slurry is disclosed in U.S. Pat. No. 4,952,558 issued to Goertz et al., where the organic solvents used to carry out the slurry polymerizations are various alkyl acetates.

Solution polymerizations of PMVE/MA in which the resultant polymer product is a slurry are especially desired if the PMVE/MA is to be isolated as a dry powder. The PMVE/MA slurries in organic solvent can be directly dried or filtered and then dried to give the final dried powder. There are multiple organic solvent systems in literature that will give such slurries and include: benzene, toluene, hydrocarbons, ethers, alkyl acetates and alkyl acetate/hydrocarbon mixtures. The dried PMVE/MA powders can then be used directly or further reacted to give derivatized PMVE/MA copolymers. Such derivatized PMVE/MA copolymers include: methyl vinyl ether-maleic acid copolymers in which the anhydride copolymer is reacted with water; methyl vinyl ether-maleic half ester copolymers in which the anhydride copolymer is reacted with alcohols and methyl vinyl ether-maleic acid metal salt copolymers in which the anhydride copolymer is reacted with inorganic metal salts.

As already referred to, PMVE/MA copolymers and their derivatives are used in a number of applications where the biocompatibility of the polymer to the host is essential. These use applications include in: wound coatings, skin lotions, toothpastes and denture adhesives to name a few. Tightening regulations and toxicity concerns around such applications have placed continuing pressure on producing PMVE/MA materials having reduced impurity profiles so as to reduce potential toxicity risks when using said materials in the finished formulation. In addition, there are positive aesthetic reasons for reducing impurities since they are often the reason for undesirable color and odor bodies.

Many impurities in PMVE/MA are generated during the polymerization process and are not due to contamination of raw materials. Thus, while improving the purity of the raw materials used in the polymerization will reduce some impurities, impurities generated during the polymerization still occur and remain in the isolated PMVE/MA polymer. These impurities increase the toxicity risk of using the product in finished formulations and/or can potentially negatively impact the polymer's aesthetics.

These impurities include initiator fragments and the reaction of the monomers with trace levels of water that is inherently in the system. The hydrolysis of MVE is especially difficult to completely prevent during the polymerization process because there is always some trace water in the system that causes a small amount of acetaldehyde generation. Acetaldehyde is a trace impurity that can further react to generate a number of small molecule impurities. The following reaction scheme shows the resultant products from the hydrolysis of MVE.

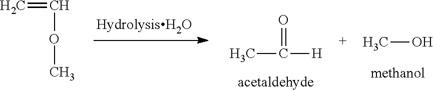

Acetaldehyde is a highly reactive molecule that can further undergo reactions that result in a host of trace impurities. Acetaldehyde-based aldol condensation reactions

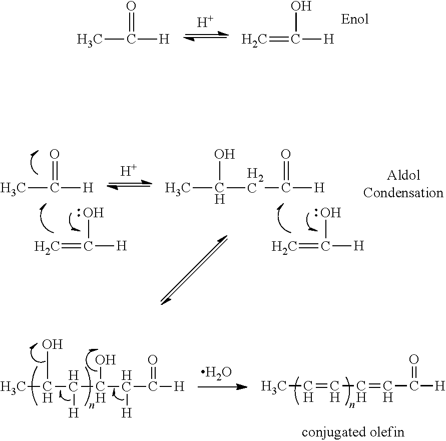

and coupling reactions

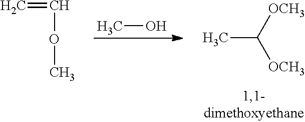

may result in a complex mix of potential trace impurities that can generate toxicity, stability and/or aesthetic concerns in the finished PMVE/MA product and its derivatives.

Thus, there is a great need for methods to remove such impurities after the polymerization is completed for certain highly demanding applications where the PMVE/MA copolymer must meet high quality standards (e.g. extremely low residual impurities, low color, low odor, high stability, etc.). There is significant patent literature that describes various processes to make PMVE/MA. However, most of this literature focuses on various solvent systems and conditions used to make said polymers, but say very little with respect to trace impurity levels in the resulting PMVE/MA copolymers.

One exception to this is the removal of the impurity benzene, which traditionally was and still is used as the solvent for some commercial production of high molecular weight PMVE/MA copolymers. U.S. Pat. No. 2,782,182 identifies the use of benzene solvent for the synthesis of PMVE/MA. Though some commercial PMVE/MA material is still manufactured using benzene and the resultant powders contain up to 2% residual benzene, it should be understood that such materials are not desirable from a benzene toxicity standpoint and greatly limits their acceptance and use in various consumer applications. For this reason, synthetic processes using alternative solvents to make PMVE/MA copolymers have been the main focus of recent patent filings.

U.S. Pat. Nos. 4,962,185; 5,047,490; 6,624,271 and 6,881,803 identify the use of the solvents toluene, methyl vinyl ether, isopropyl acetate and ethyl acetate, respectively to make PMVE/MA copolymers. Whereas more patents focus on various processes to make PMVE/MA copolymers, in all cases there is little discussion or mentioning of the trace impurities in the resultant PMVE/MA copolymer.

Though the level and type of solvent residuals in PMVE/MA copolymers are very important for assessing product safety, understanding the product's overall impurity profile is becoming the norm for properly assessing the risk of a product, especially when used in pharmaceutical, medical device, oral care and human contact applications. No longer is it acceptable to purely focus on monomer and solvent residuals when conducting a proper risk assessment. In addition, it is often trace impurities in the product that effects its resultant aesthetic, which may include such elements as: color, haze, odor and stability. The first goal to producing the highest quality product possible is to understand the exact chemical composition and concentration of said impurities. It is quite obvious that a product containing 1% residual benzene solvent would have a very different risk assessment than the same product containing 1% ethanol solvent. When determining the exact chemical composition of the impurity is not possible, then the goal is to limit unknown impurity concentrations to as low levels as possible. FDA guidelines (year 1999) suggest that any impurity over 0.1% (1000 ppm) should be identified. As risk assessments become more rigorous, this threshold is expected to become even lower. Thus, it is quite apparent that a process that can reduce individual trace impurities to well below 1000 ppm levels in PMVE/MA copolymers would be highly desirable.

Quite unexpectedly, the present inventors discovered that PMVE/MA copolymers can be efficiently and effectively “washed” of undesirable trace impurities to give ultra-pure PMVE/MA copolymers. The PMVE/MA dry powders or filtered wet slurries can be “washed” with a specific solvent solvent system in which the impurities are soluble in, but the PMVE/MA is insoluble in and the solvent and PMVE/MA do not react with each other.

Accordingly, the invention provides a process to provide an ultra-pure methyl vinyl ether-co-maleic anhydride material by solvent washing a methyl vinyl ether-co-maleic anhydride (PMVE/MA) copolymer with a solvent, comprising the steps of:
(1) providing a solvent system in which impurities in the copolymer matrix are soluble and in which the PMVE/MA copolymer is not soluble, and wherein the solvent system does not react with the copolymer;
(2) washing a dry powder or wet filter cake of PMVE/MA copolymer with the solvent system to efficiently and effectively extract trace impurities from the copolymer matrix;
(3) filtering said copolymer from the solvent system; and
(4) drying the subsequent wet filter cake of said copolymer to obtain an ultra-pure methyl vinyl ether-co-maleic anhydride copolymer.

Acceptable solvent systems include many of the same solvent systems that are used for carrying out the solution polymerizations of PMVE/MA resulting in a slurry polymer product. According to the invention, the solvent system used solubilizes impurities that are present in the copolymer matrix. These include any type of reaction impurities, like acetaldehyde and methanol, and initiator fragments, as well as further reaction products thereof that can result in a host of trace impurities. In one embodiment, the impurities comprise one or more of dimethoxy ethane (DME), trimethoxy butane (TMB), acetaldehyde and methanol. The actual solvent system chosen may be dependent on additional issues such as toxicity, ease of handling, resultant PMVE/MA slurry/powder characteristics, filtering efficiency, ease of solvent removal and/or ease of solvent recovery.

Useful solvent systems include chlorinated solvents, hydrocarbons, acetates, nonreactive alcohols, toluene, ethers and mixtures thereof. Solvent systems especially suited for the present process are methylene chloride, isopropyl acetate, ethyl acetate, isopropyl acetate, cyclohexane, pentane, hexane, cyclohexane, heptane, t-butanol, toluene, methyl vinyl ether and mixtures thereof.

In one embodiment, the solvent system is a mixture of isopropyl acetate and cyclohexane, preferably in the range of 15-30 wt % isopropyl hexane and 70-85 wt % cyclohexane. In a specific aspect, the solvent system is 25% isopropyl acetate/75% cyclohexane.

In another embodiment, the solvent system is a mixture of ethyl acetate and cyclohexane, preferably in the range of 40-60 wt % ethyl acetate and 60-40 wt % cyclohexane, such as 50-60 vol % ethyl acetate and 50-40 wt % cyclohexane, In a specific aspect, the solvent system is 54% ethyl acetate/46% cyclohexane.

In yet another embodiment, the solvent system consists of a single solvent, such as toluene, methylene chloride, dichloromethane, isopropyl acetate, methyl vinyl ether or t-butanol.

Good results are also obtained with a mixture of hexane and t-butanol, for example 60-90 wt % hexane and 40-10 wt % t-butanol. In a specific embodiment, the solvent system is 75% hexane/25% t-butanol.

The ratio of wash solvent to PMVE/MA can be determined using routine optimization procedures. In one embodiment, a process according to the invention uses in step (2) a weight ratio of wash solvent to PMVE/MA copolymer in the range of 1:1 to 20:1 wt/wt, preferably 1:1 to 10:1 wt/wt, more preferably 3:1 to 6:1 wt/wt.

The “washing” can be further optimized by running the wash process at an optimized temperature and time period. Wash temperatures are highly dependent on the solvent system used, but generally take place in a temperature range of 20-140° C., preferably in the range of 30-110° C., more preferably 60-100° C. The actual wash process can take place in a continuous manner (e.g similar to a Soxhlet extraction or percolation procedure) or individual batch wash cycles. A batch wash cycle is defined as the process of adding the solvent to the PMVE/MA powder or wet slurry, extracting the PMVE/MA for a desired time at a desired temperature and filtering said slurry to give the wet PMVE/MA filter cake. The length of the extraction (whether continuous or batch) and number of batch wash cycles is generally determined by the impurity level desired, but the total extraction time is typically in the range of 5 minutes to 48 hours, preferably 2 hours to 24 hours.

The final washed and filtered wet PMVE/MA cake is then dried in a dryer. The dryer conditions optimized to dry the PMVE/MA wet cake in a period of 1-48 hours, preferably 8-24 hours. The resultant ultra-pure PMVE/MA is a fine, white powder having individual impurity levels, except for solvent, of less than 5000 ppm, preferably less than 1000 ppm and most preferably less than 100 ppm. The levels of solvent residuals are generally determined by Q3C solvent guidance levels as outlined by the FDA or by customer risk assessment.

It should also be noted that alone filtering the slurry from the initial polymerization solvent can signficiantly improve the resultant PMVE/MA impurity profile. A significant fraction of the trace impurities can be dissolved in the polymerization solvent, which is removed with the solvent filtrate during filtering. For some applications, this can be acceptable at reducing the trace impurity levels to acceptable levels. Thus, there is no need for an actual wash step and the direct filtration of the polymerization slurry is satisfactory. However, because there is significant polymerization solvent entrapped in the powder matrix, which also contains trace impurities, subsequent washing is often necessary to remove trace impurities to very low levels.

Accordingly, the invention also provides an ultra-pure methyl vinyl ether-co-maleic anhydride copolymer or a derivative thereof having individual impurity levels, except for solvent, of less than 5000 ppm, preferably less than 1000 ppm and most preferably less than 100 ppm. In particular, it provides ultra-pure methyl vinyl ether-co-maleic anhydride copolymer or a derivative thereof, having individual impurity levels of one or more of 1,1-dimethoxy ethane (DME), trimethoxy butane (TMB) levels, acetaldehyde and methanol, of less than 5000 ppm, preferably less than 1000 ppm and most preferably less than 100 ppm.

The ultra-pure methyl vinyl ether-co-maleic anhydride copolymer or derivative thereof has improved impurity profiles and thus significantly improved toxicity risk assessment as compared to products known in the prior art. The ultra-pure methyl vinyl ether-co-maleic anhydride copolymer derivative can be an ultra-pure methyl vinyl ether-co-maleic anhydride copolymer reacted with water, alcohol and/or metal salts.

In one embodiment, the invention provides an ultra-pure methyl vinyl ether-co-maleic acid copolymer, methyl vinyl ether-co-maleic half ester copolymer, methyl vinyl ether-co-maleic acid sodium/calcium mixed salt or methyl vinyl ether-co-maleic acid calcium/zinc mixed salt.

In addition to the washed PMVE/MA copolymers showing low levels of impurities, the copolymers when further reacted to their related derivatives show further desirable properties, including improved aesthetic characteristics, reduced odor, reduced color, improved clarity and improved stability.

The wash process according to the present invention may also be advantageously applied to improve the impurity profiles of other maleic anhydride copolymer systems, including ethylene-maleic anhydride, isobutylene-maleic anhydride, MVE-isobutylene-maleic anhydride, vinyl ether-maleic anhydride, vinyl pyrrolidone-maleic anhydride and styrene-maleic anhydride.

A still further embodiment relates to a composition or device comprising an ultra-pure methyl vinyl ether-co-maleic anhydride copolymer or a derivative thereof according to the invention. For example, the composition is a pharmaceutical composition, a personal care composition, an oral care composition or a wound care composition. In a preferred aspect, the device is a medical device.

All of the compositions, methods and experiments disclosed and claimed herein can be made and executed without undue experimentation in light of the present invention. While the compositions, methods and experiments of this invention have been described in terms of preferred embodiments, it will be apparent to those skilled in the art that variations may be applied to the compositions and methods and in the steps or in the sequence of steps of the method described herein without departing from the concept, spirit and scope of the invention. All modifications and applications apparent to those skilled in the art are deemed to be within the spirit, scope and concept of the invention.

### LEGEND TO THE FIGURES

FIG. 1: GC chromatograph of impurity concentrate from untreated commercial PMVE/MA copolymer.

FIG. 2: GC chromatograph of an impurity concentrate from washed commercial PMVE/MA copolymer using a process of the invention.

FIG. 3: GC chromatograph of the impurity concentrate of the original PMVE/MA copolymer before dichloromethane wash from Example 4.

FIG. 4: GC chromatograph of the impurity concentrate of the PMVE/MA copolymer after being washed twice with dichloromethane from Example 4.

FIG. 5: Expanded GC chromatograms showing the TMB impurity peak reduction with solvent reference for the toluene wash sequence conducted at 75° C. (for details see Example 6 and Table 5). Panel A: original PMVE/MA copolymer sample comprising 321 ppm TMB. Panel B: after 1st wash, comprising 102 ppm TMB. Panel C: after 2nd wash, comprising 63 ppm TMB.

### EXPERIMENTAL SECTION

### Impurity Analysis Method:

Five grams of dry PMVE/MA copolymer powder is placed in a Soxhlet extractor and extracted with 300 ml of analytical grade methylene chloride for 24 hrs. The methylene chloride is concentrated to approximately 5 ml and the concentrate analyzed by direct GC injection. Standard curve analysis is used to determine exact amounts of dimethoxy ethane (DME) and trimethoxy butane (TMB) in the extracted samples.

Though all impurities showed significant reduction after the wash process, determining all impurity compositions and concentrations was unrealistic. Instead, the impurities DME and TMB were followed to show the decrease in impurity levels. Both DME and TMB are due to acetaldehyde side reactions and represent the type of impurities expected during the polymerization process to make PMVE/MA copolymers.

### Example 1: Comparison of GC Chromatograms of PMVE/MA Before and After Wash Process Using Dichloromethane Solvent

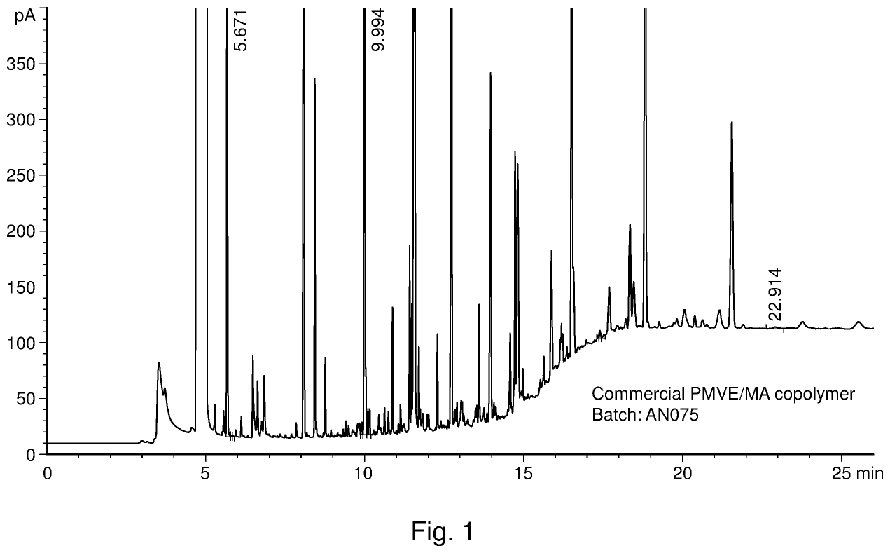

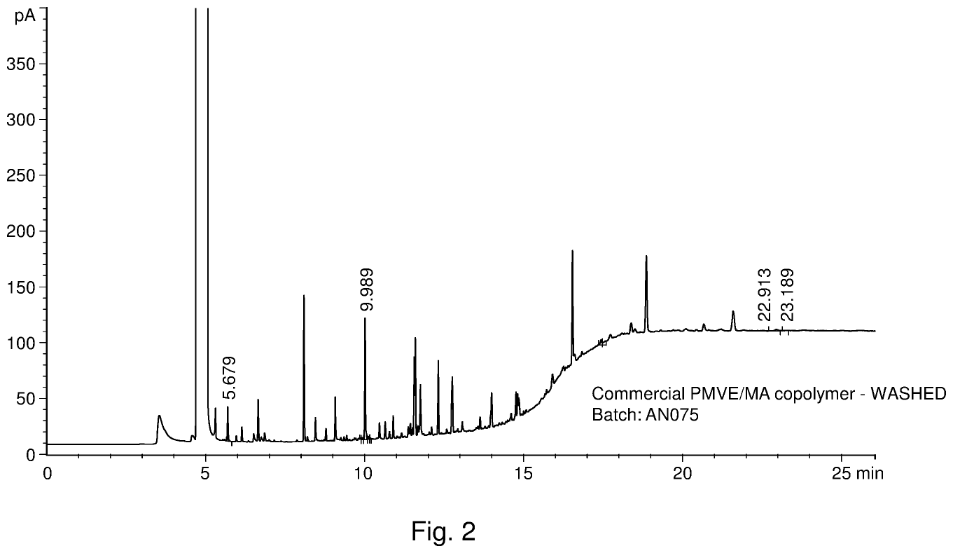

Commercial PMVE/MA batch AN075 was washed with a 5-fold excess of dichloromethane. The temperature for the extraction was 40° C. and a total of 2 batch extractions were conducted for a period of 3 hr each. The GC chromatograms for the resultant impurity concentrate for the normal and washed batches are shown in FIGS. 1 and 2, respectively.

As can be seen from the GC chromatograms, all impurities are significantly reduced as a result of the wash process. DME and TMB levels for the unwashed AN075 were 208 and 313 ppm, respectively. The DME and TMB levels after undergoing the wash process were 12 and 60 ppm, respectively.

### Example 2: Wash Experiment of PMVE/MA Copolymer Using Ethyl Acetate/Cyclohexane Solvent Mix

PMVE/MA batch AN088 was washed multiple times with a 4-fold excess of ethyl acetate/cyclohexane solvent mix (weight ratio 54:46). Each wash cycle was conducted at 70° C. for 3 hr, the product filtered, a sample taken for impurity testing and then underwent the subsequent wash cycles. In total, four wash cycles were conducted on the PMVE/MA copolymer. Table 1 shows the reduction of TMB after each wash cycle.

TABLE 1

| Sample | Wash cycle | TMB (ppm) |
|---|---|---|
| AN088 original | 0 | 49 |
| AN088-1 wash | 1 | 5 |
| AN088-2 wash | 2 | 2 |
| AN088-3 wash | 3 | 1 |
| AN088-4 wash | 4 | 0.6 |

As can be observed in Table 1, the ethyl acetate/cyclohexane 54/46 by wt mixture is an excellent solvent system for the removal of trace impurities in the PMVE/MA copolymer. The exact number of washes is developed depending on the product requirement with respect to allowable trace impurities.

### Example 3: Effect of Wash Time on the Removal of Trace Impurities in PMVE/MA Copolymers

A batch of PMVE/MA copolymer was washed with ethyl acetate/cyclohexane 54/46 wt solvent mix for varying wash durations. The wash temperature was 73° C. and the amount of solvent used was 3-fold excess of copolymer. The effect of wash duration on impurity removal is summarized in Table 2 below.

TABLE 2

| | | |
|---|---|---|
| Sample | Wash Duration | TMB (ppm) |

| | | |
|---|---|---|
| PMVE/MA original | 0 | 90 |

| | | | |
|---|---|---|---|
| PMVE/MA-W | 15 | min | 67 |
| PMVE/MA-W1 | 1 | hr | 26 |
| PMVE/MA-W2 | 2 | hr | 18 |
| PMVE/MA-W3 | 3 | hr | 16 |
| PMVE/MA-W4 | 6 | hr | 8 |

As can be seen in the table, the duration of washing step (2) in a method of the invention is an important factor in removing trace impurities from the PMVE/MA matrix. This is not surprising, because impurities are expected to be both on the powder surface and entrapped in the polymer powder matrix and thus the polymer must have time to swell so the impurities can be released and washed away. The final number and duration of individual wash cycles will typically depend on balancing economic factors and required degree of impurity removal.

### Example 4: Wash Experiment of PMVE/MA Copolymer Using Dichloromethane Solvent

PMVE/MA batch OAS160501002 underwent multiple dichloromethane wash cycles and DME and TMB impurity levels monitored after each wash cycle. The temperature for each solvent wash cycle was conducted at 50° C. for 3 hr and the amount of solvent used was 4-fold excess of copolymer based on weight. The following Table 4 shows a summary of the impurity results.

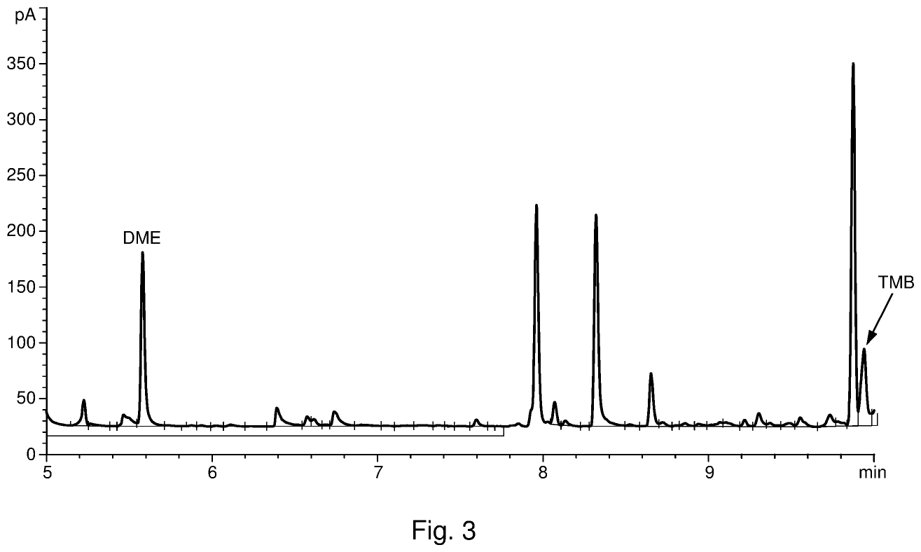

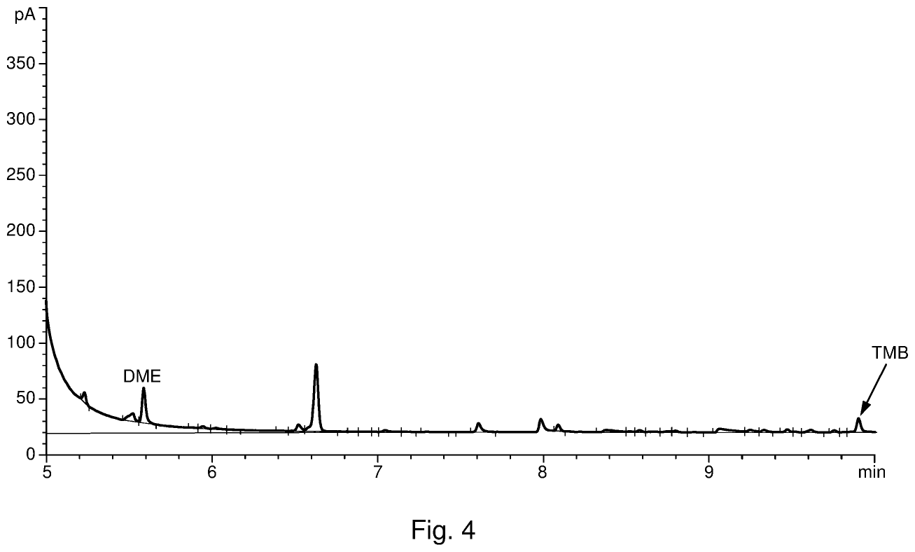

TABLE 4

| Sample | DME (ppm) | TMB (ppm) |
|---|---|---|
| PMVE/MA original | 52 | 66 |
| (see FIG. 3) | | |
| PMVE/MA-1^{st} wash | 9 | 20 |
| PMVE/MA-2^{nd} wash | 0.8 | 2 |
| (see FIG. 4) | | |
| PMVE/MA-3^{rd} wash | 0.6 | 0.7 |
| PMVE/MA-4^{th} wash | 0.3 | 0.3 |

The GC chromatograph representing the impurity profile for the original PMVE/MA sample is shown in FIG. 3 with both DME and TMB impurities identified. FIG. 4 shows the resultant GC chromatograph of the extracted impuities from the PMVE/MA powder after being washed twice with dichloromethane.

### Example 5: Wash Experiments of PMVE/MA Copolymer Using a Methyl Vinyl Ether Solvent System

PMVE/MA material OAS170308014 underwent 3 wash cycles, with each wash cycle using a 3-fold weight excess of methyl vinyl ether at 35° C. for 3 hr. The TMB level for the initial PMVE/MA copolymer before wash was 59 ppm and the TMB level after the 3 wash cycles was 5.2 ppm.

### Example 6: Wash Experiments of PMVE/MA Copolymer Using a Toluene Solvent System

PMVE/MA material OAS170108002 was washed with a 4-fold excess of toluene by weight. Both the wash temperature and number of wash cycles were varied to see the effect on impurity removal while the actual wash duration was kept at 3 hr. The following Table 5 shows a summary of the results.

TABLE 5

| | Wash Temp. | |
|---|---|---|
| Sample | (° C.) | TMB (ppm) |
| PMVE/MA original | — | 321 |
| PMVE/MA-1^{st} wash | 75 | 102 |
| PMVE/MA-2^{nd} wash | 75 | 63 |
| PMVE/MA-1^{st} wash | 100 | 26 |
| PMVE/MA-2^{nd} wash | 100 | 4.1 |

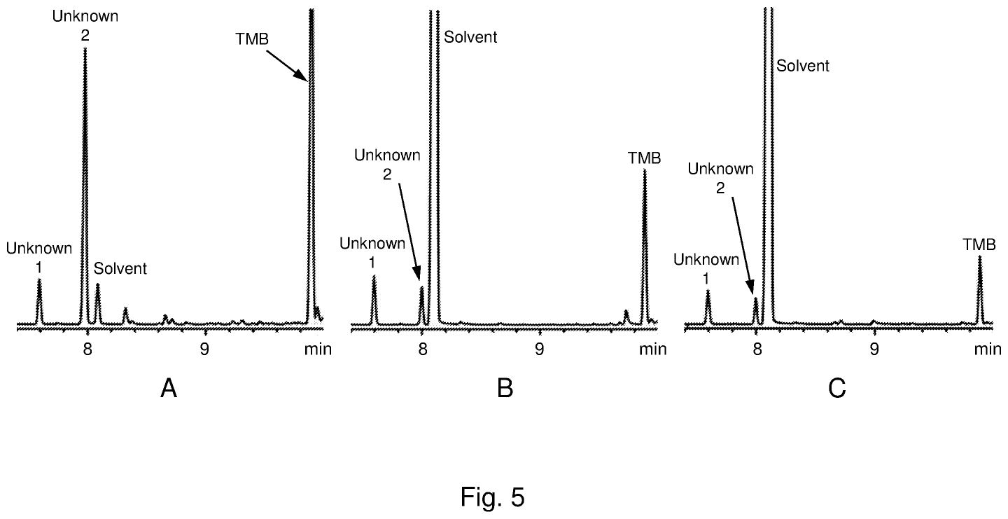

As can be seen from the table, not only the number of wash cycles, but the wash temperature can effect the rate of impurity removal. The actual GC chromatographs for the wash sequence conducted at 75° C. are included in FIG. 5. The chromatographs have been enlarged and the TMB impurity peak identified.

### Example 7: The Effect of Impurity Removal Based on Composition of Solvent System

PMVE/MA material AN024M underwent one wash cycle using various solvent systems. The wash process was conducted at 70° C. for 3 hr with a 4-fold excess of solvent to copolymer based on weight. The following table 6 is a summary of the results.

TABLE 6

| Sample | Wash solvent system | TMB (ppm) |
|---|---|---|
| AN024M original | — | 31 |
| AN024-CH | cyclohexane | 35* |
| AN024-IC | 25% isopropyl acetate/75% cyclohexane | 25 |
| AN024-EC | 54% ethyl acetate/46% cyclohexane | 5 |
| AN024-IPAc | Isopropyl acetate | 10 |
| AN024-HTB | 75% Hexane/15% t-butanol | 23 |
| AN024-TB | t-butanol | 12 |

*no significant decrease based on original sample. Within the test data error.

1. A process to provide an ultra-pure methyl vinyl ether-co-maleic anhydride material by solvent washing a methyl vinyl ether-co-maleic anhydride (PMVE/MA) copolymer with a solvent, comprising the steps of:
(1) providing a solvent system in which one or more impurities in the copolymer matrix are soluble and in which the PMVE/MA copolymer is not soluble, and wherein the solvent system does not react with the copolymer;
(2) washing a dry powder or wet filter cake of PMVE/MA copolymer with the solvent system to efficiently and effectively extract trace impurities from the copolymer matrix;
(3) filtering said copolymer from the solvent system; and
(4) drying the subsequent wet filter cake of said copolymer to obtain an ultra-pure methyl vinyl ether-co-maleic anhydride copolymer.

2. The process according to claim 1, wherein the one or more impurities comprise one or more of dimethoxy ethane (DME), trimethoxy butane (TMB), acetaldehyde and methanol.

3. The process of claim 1, wherein the solvent system is selected from the group consisting of chlorinated solvents, hydrocarbon, acetates, nonreactive alcohols, aromatics, ethers and any mixture thereof.

4. The process of claim 3, wherein the solvent system comprises methylene chloride, isopropyl acetate, ethyl acetate, isopropyl acetate, cyclohexane, pentane, hexane, cyclohexane, heptane, t-butanol, toluene, or methyl vinyl ether or mixtures thereof.

5. The process according to claim 1, wherein the weight ratio of wash solvent to PMVE/MA copolymer in step (2) is in the range of 1:1 to 20:1 wt/wt.

6. The process according to claim 1, wherein the wash temperature during step (2) is in the temperature range of 20-140° C.

7. The process according to claim 1, wherein step (2) is performed in a continuous manner or individual batch wash cycles.

8. The process according to claim 1, wherein the total extraction time of step (2) is in the range of 5 minutes to 48 hours.

9. An ultra-pure methyl vinyl ether-co-maleic anhydride copolymer or a derivative thereof having individual impurity levels, except for solvent, of less than 5000 ppm.

10. The ultra-pure methyl vinyl ether-co-maleic anhydride copolymer or a derivative thereof according to claim 9, having individual impurity levels of one or more of methoxy ethane (DME), trimethoxy butane (TMB) levels, acetaldehyde and methanol, of less than 5000 ppm.

11. The ultra-pure methyl vinyl ether-co-maleic anhydride copolymer derivative of claim 9, being ultra-pure methyl vinyl ether-co-maleic anhydride copolymer reacted with water, alcohol and/or metal salts.

12. The ultra-pure methyl vinyl ether-co-maleic anhydride copolymer derivative of claim 11, being a methyl vinyl ether-co-maleic acid copolymer, methyl vinyl ether-co-maleic half ester copolymer, methyl vinyl ether-co-maleic acid sodium/calcium mixed salt or methyl vinyl ether-co-maleic acid calcium/zinc mixed salt.

13. A composition or device comprising an ultra-pure methyl vinyl ether-co-maleic anhydride copolymer or a derivative thereof according to claim 9.

14. The composition or device of claim 13, being a pharmaceutical composition, a medical device, a personal care composition, an oral care composition or a wound care composition.
